(19) United States
(12) Patent Application Publication
(10) Pub. No.: US 2025/0217110 A1
(43) Pub. Date: Jul. 3, 2025

(54) EQUATION-BASED PROCESSING DATA STRUCTURE

(71) Applicant: Caret Holdings, Inc., Columbus, OH (US)

(72) Inventors: Jason Christopher Randal Miller, Naperville, IL (US); Derrick Christopher Spell, Oswego, IL (US)

(21) Appl. No.: 18/397,922

(22) Filed: Dec. 27, 2023

(51) Int. Cl. G06F 7/544; G06F 9/451

(52) U.S. Cl. CPC G06F 7/544; G06F 9/451

(57) ABSTRACT

An equation is modeled within a data structure representing a tree with operands and operators of the equation represented as nodes of the tree. The structure of the tree represents the structure and semantics of the equation. The data structure includes or linked to executable code which permits components or subtrees of the data structure to be executed with output passed up through the tree to other executable code associated with other nodes of the tree. The data structure can be eagerly or lazily executed in whole or in part. In an embodiment, each node is represented as an object with attributes and methods. The methods set values on the attributes and/or initiate the corresponding executable code associated with the node. In an embodiment, at least one method permits comments or annotations to be set on one more attributes of a corresponding object.

Many data processing results which are needed to drive operations and services are based on complicated and lengthy equations. For example, insurance premium calculations include a substantial number of variables, each variable value contributes a portion to the overall premium. However, discovering or isolating the portion that a given variable value contributes to the overall premium is a processor intensive exercise because there are so many dependencies between the variables in the premium equation for the overall premium. The manner in which the variables and variable values depend upon one another cannot simply be obtained by changing a variable value for a given variable. Furthermore, the issue is not restricted to insurance companies in fact any complicated equation used in risk analysis, prediction analysis, fraud analysis, and others encounter similar issues associated with determining how a single variable value impacts an overall decision or result produced by a corresponding complicated equation.

Additionally, variable interdependencies in complicated equations also make it extremely difficult to debug, make code changes to, and support the equations. In fact, changes to the equations or the code associated with the equations often require substantial programming resources and take a considerable amount of elapsed time to implement.

### BRIEF DESCRIPTION OF THE DRAWINGS

FIG. 1 is a diagram of a system for providing and integrating an equation-based processing data structure into network services, system services, mobile applications and/or browsers, according to an example embodiment.

FIG. 2 is a diagram of an example equation-based processing data structure for an insurance premium equation, according to an example embodiment.

FIG. 3 is a flow diagram of a method for providing an equation-based processing data structure, according to an example embodiment.

FIG. 4 is a diagram of another method for integrating an equation-based processing data structure into a network service, a system service, a mobile application, and/or a browser, according to an example embodiment.

### DETAILED DESCRIPTION

In various embodiments, methods and a system for providing and integrating evaluations or calculations on an equation-based processing data structure are provided. An equation is broken down into types of objects and represented as an abstract syntax tree (AST) data structure within memory and/or storage of a device. The object types are nodes located at different hierarchical levels of the AST data structure while dependencies between the object types are modeled as branches between the nodes of the AST data structure.

As will be demonstrated herein and below the AST data structure (hereinafter just “AST”) is processed to evaluate custom scenarios or conditions associated with the equation to provide processor and memory efficient results to a network service, a system service, a mobile application, and/or a browser. The AST can be lazily and/or eagerly evaluated in real time based on the custom conditions. The AST can be evaluated to identify an impact by a given condition or a given set of conditions on the overall output result produced by the equation. Furthermore, the objects of the AST include comments or annotations allowing the AST to identify components of the equation known to be more adversely impacted by a bug. The AST can be evaluated to perform granular impact analysis versus different component impact analysis. The AST can be evaluated to generate partial results from custom sub components of the equation, to provide compliance evidence for the equation, to debug issues detected within the equation, to compute an impact of each component on the overall results from the equation, to validate intended or planned changes to the equation, to maintain partial computed results from different components or the equation within a cache or a log so as to provide fast response times when evaluating the equation for a given change being proposed in real time, and to adapt equation results through partial re-evaluation of the equation without processing the entire equation.

In an embodiment, the cache or log includes a local storage or memory for a given node of a plurality of nodes for the AST. A given node holds a value and when the value is requested, the node returns an already previously computed value and/or computes the value, stores it locally, and returns the computed value. In an embodiment, the cache or log is a read-through cache.

In an embodiment, and in certain nodes where auditing or subsequent mutation is not necessary, the certain nodes can be represented as constant values instead of functions for optimization. For example, if a node is a function that adds 1 and the input value is 2, then the node within the AST can be replaced with a constant value of 3 as soon as the node associated with the input value of 2 is evaluated a first time for the equation represented in the nodes of the AST. This permits the AST itself to be reduced or consolidated such that it can become extremely small, awaiting only some final missing input values. For example, when the equation is associated with computing an insurance premium, and the only missing variable value is a driver's age, the entire AST can be evaluated by converting all nodes into constants and pruning previously dependent nodes such that the AST shrinks down to just a function node that requires age, a constant node that holds the value of evaluating the remainder of the equation, and a node that combines those two nodes, i.e., the AST becomes something akin to a factor for age function times a partially computed factor. The AST can be persisted or transmitted in this form such that the final evaluation of the equation can be done extremely quick and processor efficient, i.e., “just in time.”

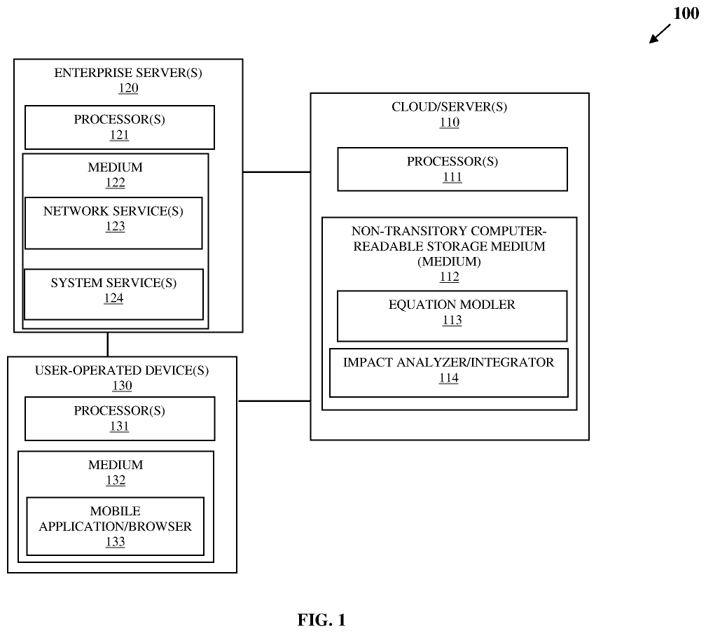

FIG. 1 is a diagram of a system 100 for providing and integrating an equation-based processing data structure into network services, system services, mobile applications and/or browsers, according to an example embodiment. Notably, components of system 100 are shown in simplified form with just those components necessary for comprehending the teachings presented herein being illustrated. More or less components are intended to fall within the scope of the beneficial teachings presented herein.

System 100 includes at least one cloud 110 or server 110 (herein after just “cloud 110”), a plurality of enterprise servers 120, and a plurality of user-operated devices (herein after just “devices”) 130. Cloud 110 includes at least one processor 111 and a non-transitory computer-readable storage medium (herein after just “medium”) 112, which includes instructions for an equation modeler 113 and an impact analyzer/integrator (herein after just “impact analyzer”) 114. When the processor 111 executes the instructions, this causes the processor 111 to perform operations discussed herein and below with respect to 113 and 114.

Each enterprise server 120 includes at least one processor 121 and medium 122, which includes instructions for one or more network services 123 and/or one or more system services 124. When the processor 121 executes the instructions, this causes the processor 121 to perform operations discussed herein and below with respect to 123 and/or 124.

Each device 130 includes at least one processor 131 and medium 132, which includes instructions for a mobile application/browser 133. When the processor 131 executes the instructions, this causes the processor 131 to perform operations discussed herein and below with respect to 133.

Initially, equation modeler 113 obtains or is provided a complex equation associated with a large number of variably resolved operands, constant operands, and a plurality of mathematical or function-based operators. Equation modeler 113 decomposes the equation into object types, each object type representing a particular operand or a particular operator in the equation. The equation modeler 113 creates instances of the objects based on their corresponding object types. Each object includes attributes and a method for performing a designated operation. In an embodiment, at least one method permits comments or annotations to be set on a corresponding comment or annotation attribute.

The equation modeler 113 resolves the object types based on the types of operand for the equation and the results expected to be produced when the equation is processed. For example, an insurance premium calculation to provide a car insurance rate to a customer includes factors (operand types) to calculate an insurance rate. There are a plethora of factor types associated with the premium calculation such as, and by way of example only, a base factor, an average driver factor, a household structure factor, a financial responsibility factor, a territory factor, a vehicle age factor, months of continuous insurance factor, months since insurance cancellation factor, accident free discount factor, not at fault accident count factor, homeowner factor, financial responsibility factor, etc. The premium equation resolves each factor value for each factor type based on one or more features with corresponding feature values and/or based on applying operators on the feature values. Once the factor values are resolved, the premium equation applies additional operators and/or functions on certain factor values and calculates an insurance rate.

The equation modeler 113 creates instances of the node types and arranges the node types into an AST data structure based on dependencies between the node instances as defined in the equation. The equation modeler 113 maintains the AST data structure in memory and/or storage of the cloud 110 as a generic instance of the equation, which can be processed to obtained results, partially processed to obtain partial results, evaluated to determine impacts of changing one or more operand values or conditions in an overall result provided by the equation vis-à-vis one or more other unchanged operand values of unchanged conditions, eagerly evaluated, lazily evaluated, etc. The code associated with the equation is not changed. However, evaluation of the equation represented as the AST data structure can pinpoint locations in the code for the equation that should or can be changed without introducing bugs and/or to improve results produced by the equation.

Impact analyzer 114 provides an application programming interface (API) for custom accessing and evaluating the AST data structure representing the equation. Conditions or parameters provided as input are passed through the API to fully or partially execute and/or evaluate the equation represented in the AST data structure. Impact analyzer 114 also uses an API to receive the conditions or parameters from network services 123, system services 124, and/or mobile application (app)/browser 133. The results obtained from the equation based on the conditions or parameters are communicated back from the impact analyzer 114 to the network services 123 and/or system services 124.

In an embodiment, the AST data structure is persisted. It can be persisted in fully unevaluated form, partially evaluated form, and/or fully evaluated form. The logic of the equation is represented within the AST data structure via the nodes/objects, which means that it can be stored and/or transmitted, and evaluation can continue on recall or receipt accordingly.

System 100 permits a complex equation to be decomposed into nodes representing operand types and operators and arranged in an AST data structure. The equation within the AST data structure can be evaluated, executed, partially executed, and more in real time to provide corresponding results to network services 123, system services 124, and/or mobile app/browser 133. Existing complex equations are processor intensive, memory intensive, difficult to evaluate for purposes of code changes needed for the equation and for purposes of identifying bugs in the equation, and not provide a mechanism for identifying potential impacts based on value changes in the operands. The AST data structure solves all these issues by modeling, processing, and executing the equation in real time either completely or partially.

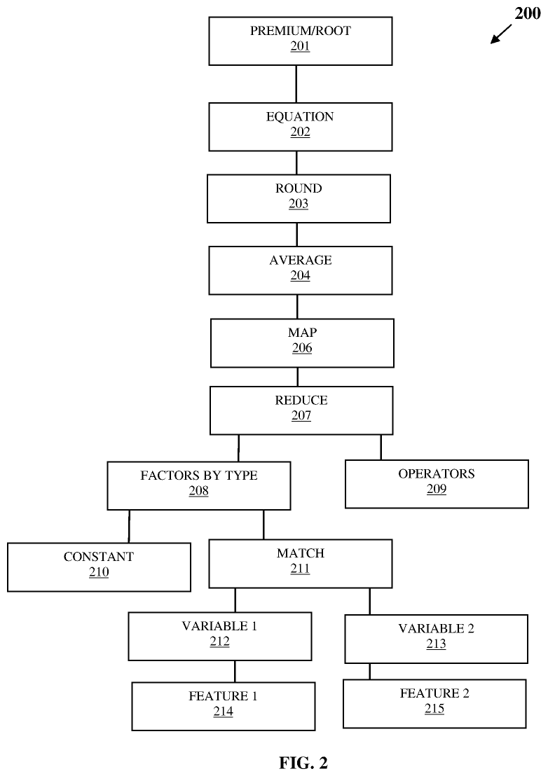

FIG. 2 is a diagram of an example equation-based processing data structure 200 for an insurance premium equation, according to an example embodiment. The data structure 200 is shown within the context of a premium equation used to provide insurance rates to customers. Notably, the teachings provided herein can also be used for any complex equation associated with, but not limited to, risk analysis, fraud analysis, prediction analysis, and others. Notably, the data structure 200 is one instance of an example premium equation presented for purposes of illustration and is not intended to represent all the nodes or operands of the premium equation. For example, the factors by type node 208 can include many branches from the reduce node, one branch by factor type. Moreover, the node types under each factor by type node can include different subtrees from what is illustrated.

The premium equation is decomposed into node types. The node types include a premium node type, an equation node type, a round node type, an average node type, a map node type, a reduce node type, a factor by type nodes, an operator node, a constant node, a match node, variable nodes, and feature nodes.

A constant node 210 type provides a hard coded value for an operand of the equation. In an embodiment, the constant node 210 includes base insurance rates. In an embodiment, the constant node 210 models the results of match lookups within the equation.

A feature node 214 and 215 represents a specific feature selection value. Each feature node 214 and 215 includes a feature identifier, and optionally a descriptive feature label or feature name. In an embodiment, feature node 214 and 215 includes a method to introspect a business rule associated with the equation; this includes fact dependencies and a description of the feature. In an embodiment, the feature node 214 or 215 is insurance plan agnostic.

A variable node 212 and 213 represents a given feature node value and wraps a corresponding feature node 214 and 215 by identifying the correct feature identifier for a given insurance plan and by mapping the corresponding feature node's name to an engineering name or engineering terminology. In this way, a variable node 212 and 213 provides indirection that can be used from impact analysis to metaprogramming by programmers.

A match node 211 represents a function to transform source values associated with any mode type into a single value. In an embodiment, the match function produces a factor value for a given factor type used in the equation. In an embodiment, the match function produces a value from values provided by multiple other match nodes 211.

A map node 206 includes a child node and a target identifier. Evaluating a map node 206 produces a list of values, produced by evaluating the child node for each element in input data to the equation (the input data may be referred to as “fact data” herein) for the target identifier (e.g., drivers or vehicles being evaluated by the equation). A map node 206 is always a child of an average node.

An average node 204 has a child map node 206 and produces a value that is a sum and count of the map node's produced value. An average node 204 can, optionally, round the sum before dividing by the count.

A round node 203 is an operand or a function that rounds the result of a child's node value. An operator node 209 combines a specific mathematical operation with a single node of any type (other than another operator node 209 or map node 206) to produce a partially applied function. In an embodiment, operator nodes 209 are used by a reduce node 207 to reduce values from each operator's child nodes using each operator node's mathematical operation.

A reduce node 207 reduces a list of values produced by multiple operator nodes 209 into a single value, numeric factor, or premium. A factor node 208 (identified by factors by type in data structure 200) wraps one of several different types of nodes depending upon the factor type, each as match node 211, constant node 210, or equation node 202. The match node 211 either wraps variables 212 and 213 or factors 214 and 215.

An equation node 202 wraps a list of factors with operators defined in the equation, the group of operators is optionally wrapped in an average node 204 or a round node 203. In an embodiment, a default operator is multiplication for the equation.

A premium node 201 is a special form of the equation that is based on an insurance plan or an insurance coverage. The premium node 201 is the root node of the AST data structure 200.

Every node in the AST data structure 200 is maintained as an object having attributes and methods. The AST data structure 200 represents the structure of the premium equation including its operands, operators, and functions.

Impact analyzer 114 renders the AST data structure 200 within interfaces to the network services 123, system services 124, and mobile application/browser 133 as a graphical user interface (GUI) depicting the tree structure or displayed as a GUI of certain desired component nodes. For example, within a GUI, the base factor type can be displayed along with its value of, for example, 317.16 with each of the other factor types and their corresponding value represented within the base factor value; for example, average driver factor type's value is displayed as 0.759 underneath the back factor type value of 317.16. In an instance of a customer operating device 130 and using mobile app/browser 133, the customer can interact with the GUI to see, visually, what each factor value was and how that impacted the overall base factor. The GUI can also be rendered with distinctive colors for each of the factor types' values so that the user, an analyst, or an engineer can readily distinguish impacts of an individual factor's value relative to the overall base factor's value. A user of the GUI can drill down into different levels of detail within the AST data structure 200 allowing the user to identify a particular feature value, the feature's definition or description, and raw facts used to produce that feature's variables referenced by the corresponding factors.

In an embodiment, impact analyzer 114 can generate reports and provide the reports to network services 123, system services 124, and/or mobile application/browser 133. For example, impact analyzer 114 an evaluate the AST data structure 200 to identify any unmapped rating variables in the premium equation, to construct facto graphs that show which factors depend on which rating variables, and to produce a calculation log that includes factor-by-factor premium impact (e.g., dollar amount differences versus if a given factor was instead flat or a different value). In an embodiment, the impact analyzer 114 presents options within the GUI for a user to select a given report with user-supplied conditions, feature selections of values, coverage selection, etc. The impact analyzer 114 executes all or a portion of the AST data structure 200 and presents results back to the user within the GUI.

The AST data structure 200 functionally models a complex insurance premium equation. The model permits the impact analyzer 114 to eagerly compute or evaluate factors and passes the corresponding values computed up the tree represented by the data structure 200. The AST data structure 200 permits programmatic traversal of functional components of the equation using generic and descriptive terminology and evaluation of subsection which may require selective wrapping by upstream nodes. In an embodiment, the AST data structure 200 is lazily evaluated or executed to provide “what if” scenarios desired by users (e.g., customers, analysts, engineers).

In an embodiment, the AST data structure 200 enables metaprogramming where computed aggregations from the underlying equation are used as input to other portions of the equation. Individual component portions of the equation can be changed to execute a partial portion of the overall equation or execute the entire equation. In other words, each portion of the AST data structure 200 is executable code such that there is a series of individual executable code modules functionally interrelated and structured within the tree.

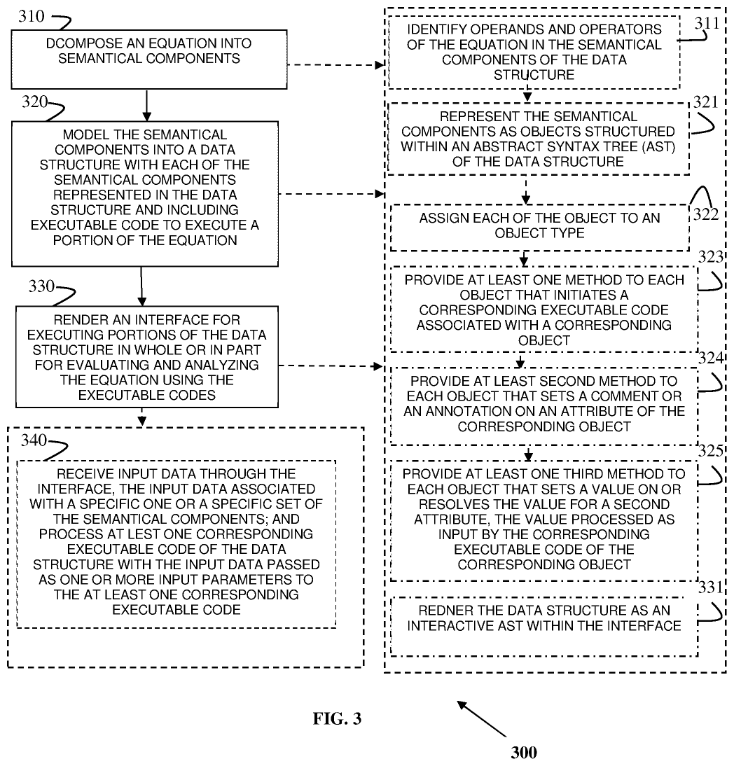

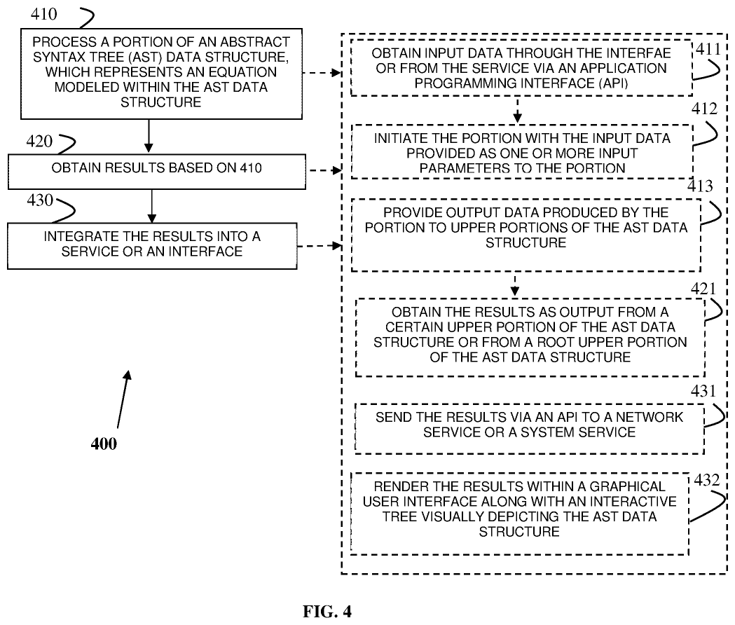

The above-discussed embodiments and other embodiments are now presented with the discussion of FIGS. 3 and 4. FIG. 3 is a flow diagram of a method 300 for providing an equation-based processing data structure, according to an example embodiment. The software module(s) that implements the method 300 is referred to as an “equation modeler” The equation modeler is implemented as executable instructions programmed and residing within memory and/or a non-transitory computer-readable (processor-readable) storage medium and executed by one or more processors of one or more devices. The processor(s) of the device(s) that executes the equation modeler are specifically configured and programmed to process the equation modeler. The equation modeler may have access to one or more network connections during its processing. The network connections can be wired, wireless, or a combination of wired and wireless.

In an embodiment, the device that executes the equation modeler is the cloud 110. In an embodiment, the device that executes the equation modeler is server 110.

In an embodiment, the equation modeler is all or some combination of 113 and/or 114. The equation modeler presents another and, in some ways, enhanced perspective of system 100.

At 310, the equation modeler decomposed an equation into semantical components. In an embodiment, at 311, the equation modeler identifies the operands and operators of the equation in the semantical components of the data structure.

At 320, the equation modeler models the semantical components into a data structure with each of the semantical components represented in the data structure and including executable code to execute a portion of the equation. In an embodiment of 311 and 320, at 321, the equation modeler represents the semantical components as objects structured within an AST of the data structure.

In an embodiment of 321 and at 322, the equation modeler assigns each object to an object type. In an embodiment, the types are the types of nodes recited above with data structure 200 of FIG. 2.

In an embodiment of 322 and at 323, the equation modeler provides at least one method or operation to each object that initiates a corresponding executable code associated with a corresponding object. In an embodiment of 323 and at 324, the equation modeler provides at least one second method to each object that sets a comment or an annotation on an attribute of the corresponding object. In an embodiment of 324 and at 325, the equation modeler provides at least one third method to each object that sets a value on or resolves the value for a second attribute, the value processed as input by the corresponding executable code of the corresponding object.

At 330, the equation modeler renders an interface for executing portions of the data structure in whole or in part for evaluating and analyzing the equation using the executable codes. In an embodiment, at 331, the equation modeler renders the data structure as an interactive AST within the interface.

In an embodiment, at 340, the equation modeler receives input through the interface. The input data is associated with a specific one or a specific set of the semantical components (nodes as discussed above with data structure 200). The equation modeler processes at least one corresponding executable code of the data structure with the input data passed as one or more input parameters to the at least one corresponding executable code.

FIG. 4 is a diagram of another method 400 for integrating an equation-based processing data structure into a network service 123, a system service 124, a mobile application 133, and/or a browser 133, according to an example embodiment. The software module(s) that implements method 400 is referred to as an “equation analyzer and integrator.” The equation analyzer and integrator is implemented as executable instructions programmed and residing within memory and/or a non-transitory computer-readable (processor-readable) storage medium and executed by one or more processors of one or more devices. The processors that execute the equation analyzer and integrator are specifically configured and programmed to process the equation analyzer and integrator. The equation analyzer and integrator may have access to one or more network connections during its processing. The network connections can be wired, wireless, or a combination of wired and wireless.

In an embodiment, the device that executes the equation analyzer and integrator is the cloud 110. In an embodiment, the device that executes the equation analyzer and integrator is server 110.

In an embodiment, the equation analyzer and integrator is all of, or some combination of 113, 114, 123, 124, 133, and/or method 300. The equation analyzer and integrator presents another and, in some ways, enhanced processing perspective of system 100 and/or method 300.

At 410, the equation analyzer and integrator processes a portion of an AST data structure, which represents an equation modeled within the AST data structure. In an embodiment, at 411, the equation analyzer and integrator obtains input data through the interface or from the service via an API. In an embodiment of 411 and at 412, the equation analyzer and integrator initiates the portion with the input data provided as one or more input parameters to the portion. In an embodiment, at 413, the equation analyzer and integrator provides output data produced by the portion to upper portions of the AST data structure.

At 420, the equation analyzer and integrator obtains results based on 410. In an embodiment of 413 and 420, at 421, the equation analyzer and integrator obtains the results as output from a certain upper portion of the AST data structure or from a root upper portion of the AST data structure.

At 430, the equation analyzer and integrator integrates the results into a service or an interface. In an embodiment, at 431, the equation analyzer and integrator sends the results via an API to a network service 123 and/or a system service 124. In an embodiment, at 432, the equation analyzer and integrator renders the results within a GUI along with an interactive tree visually depicting the AST data structure.

It should be appreciated that where software is described in a particular form (such as a component or module) this is merely to aid understanding and is not intended to limit how software that implements those functions may be architected or structured. For example, modules are illustrated as separate modules, but may be implemented as homogenous code, as individual components, some, but not all of these modules may be combined, or the functions may be implemented in software structured in any other convenient manner.

Furthermore, although the software modules are illustrated as executing on one piece of hardware, the software may be distributed over multiple processors or in any other convenient manner.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus, the following claims are hereby incorporated into the Description of the Embodiments, with each claim standing on its own as a separate exemplary embodiment.

1. A method, comprising:
decomposing an equation into semantical components;
modeling the semantical components in a data structure with each of the semantical components represented in the data structure including executable code to execute a portion of the equation; and
rendering an interface for executing portions in whole or in part for evaluating and analyzing the equation.

2. The method of claim 1, wherein decomposing further identifying operands and operators of the equation in the semantical components of the data structure.

3. The method of claim 2, wherein modeling further includes representing the semantical components as objects structured within an abstract syntax tree (AST) of the data structure.

4. The method of claim 3, wherein modeling further includes assigning each of the objects to an object type.

5. The method of claim 4, wherein modeling further includes providing at least one method to each object that initiates a corresponding executable code associated with a corresponding object.

6. The method of claim 5, wherein modeling further includes providing at least one second method to each object that sets a comment or an annotation on an attribute of the corresponding object.

7. The method of claim 6, wherein modeling further includes providing at least one third method to each object that sets a value on or resolves the value for a second attribute, wherein the value processed as input by the corresponding executable code of the corresponding object.

8. The method of claim 1, wherein rendering further includes rendering the data structure as an interactive abstract syntax tree within the interface.

9. The method of claim 1 further comprising:
receiving input data through the interface, input data associated with a specific one or a specific set of the semantical components represented in the data structure; and
processing at least one corresponding executable code of the data structure with the input data passed as one or more input parameters to the at least one corresponding executable code.

10. A method, comprising:
processing a given portion of an abstract syntax tree (AST) data structure, which represents an equation modeled within the AST data structure;
obtaining results based on the processing; and
integrating the results into a service or an interface.

11. The method of claim 10, wherein processing further includes obtaining input data through the interface or from the service via an application programming interface.

12. The method of claim 11, wherein processing further includes initiating the portion with the input data provided as one or more input parameters to the portion.

13. The method of claim 10, wherein processing further includes providing output data produced by the portion to upper portions of the AST data structure.

14. The method of claim 13, wherein obtaining further includes obtaining the results as output from a certain upper portion of the AST data structure or from a root upper portion of the AST data structure.

15. The method of claim 10, wherein integrating further includes sending the results via an application programming interface to a network service of a system service.

16. The method of claim 10, wherein integrating further includes rendering the results within a graphical user interface along with an interactive tree visually depicting the AST data structure.

17. A system, comprising:
at least one server system comprising at least one server having at least one processor and a non-transitory computer-readable storage medium having executable instructions;
the executable instructions when executed by the at least one processor cause the at least one processor to perform operations comprising:
modeling an equation within an abstract syntax tree (AST) data structure;
providing an interface for interacting with the AST data structure;
executing all or certain portions of the equation using the AST data structure and based on an interaction received through the interface; and
integrating results received from the executing into the interface.

18. The system of claim 17, wherein the interface is an application programming interface.

19. The system of claim 17, wherein the interface is a graphical user interface (GUI), wherein the GUI is an interactive GUI operated by a user for evaluating and analyzing the equation.

20. The system of claim 17, wherein the AST data structure is persisted in a fully unevaluated form, a partially evaluated form, or a fully evaluated form.
